(19) United States
(12) Patent Application Publication
(10) Pub. No.: US 2023/0150223 A1
(43) Pub. Date: May 18, 2023

(54) Flexible Honeycomb Structure and Manufacturing Method for Flexible Honeycomb Structure

(71) Applicants: BEIJING ANDER TECHNOLOGIES, Beijing (CN); MA'ANSHAN ANDER TECHNOLOGIES, Ma'anshan, Anhui (CN)

(72) Inventors: Ligang ZHENG, Beijing (CN); Zhijin PAN, Beijing (CN)

(21) Appl. No.: 17/919,760

(22) PCT Filed: Oct. 22, 2020
(86) PCT No.: PCT/CN2020/122861

§ 371 Date: Oct. 19, 2022

(30) Foreign Application Priority Data
May 26, 2020 (CN) 202010456879.6

(51) Int. Cl. B32B 3/12; B32B 3/18; B32B 38/18

(52) U.S. Cl. CPC B32B 3/12; B32B 3/18; B32B 38/1841

(57) ABSTRACT

Disclosed are flexible honeycomb structure and manufacturing method for the flexible honeycomb structure, the flexible honeycomb structure including a plurality of core lattice units, wherein each of the plurality of core lattice units is of a polygonal structure, and the plurality of core lattice units combine with each other to form the flexible honeycomb structure; and each of the plurality of core lattice units is of an inclined structure, two adjacent core lattice units in a first direction have opposite directions of inclination, two adjacent core lattice units in a second direction have a same direction of inclination, and the first direction is perpendicular to the second direction. By an adoption of technical solutions of the disclosure, a problem of a honeycomb structure and a composite material having the honeycomb structure generating a saddle shape during a bending process is solved, and a manufacturing cost for eliminating the saddle shape is reduced.

### CROSS-REFERENCE TO RELATED APPLICATIONS

This disclosure claims priority to Chinese Patent Application No. 202010456879.6, filed to the China National Intellectual Property Administration on May 26, 2020 and entitled “Flexible Honeycomb Structure and Manufacturing Method for Flexible Honeycomb Structure”.

### TECHNICAl FIELD

The disclosure relates to a technical field of flexible honeycomb structures, and in particular to a flexible honeycomb structure and a manufacturing method for the flexible honeycomb structure.

### BACKGROUND

A honeycomb structure is a structural material formed by covering a two-dimensional plane, which has a special integral honeycomb structure, and the structural material has light weight, high specific strength and excellent mechanical properties, so that it is widely applied to composite materials, particularly to fields of aerospace, high specific strength requirements, force bearing structures, impact resistance, energy absorption, noise elimination and the like.

However, in a relevant art, for parts with non-planar structure and small curvature radius, a plate-shaped honeycomb structural material manufactured by using a conventional honeycomb structure generates a saddle shape when being bent, meanwhile, the saddle shape is more obvious when a height and a breadth of the honeycomb structural material are larger. The saddle shape is difficult to eliminate, so that the material is difficult to form, a manufacturing process for eliminating the saddle shape is complex, a cost is high, a waste is large, and a quality of a product is difficult to ensure.

Therefore, a problem of the honeycomb structure and a composite material having the honeycomb structure generating a saddle shape during a bending process exists in the related art.

### SUMMARY

The disclosure provides a flexible honeycomb structure and a manufacturing method for the flexible honeycomb structure, for solving a problem of a honeycomb structure and a composite material having the honeycomb structure generating a saddle shape during a bending process in a related art.

According to an aspect of the disclosure, the flexible honeycomb structure is provided, including a plurality of core lattice units, each of the plurality of core lattice units is of a polygonal structure, and the plurality of core lattice units combine with each other to form the flexible honeycomb structure; and each of the plurality of core lattice units is of an inclined structure, two adjacent core lattice units in a first direction have opposite directions of inclination, two adjacent core lattice units in a second direction have a same direction of inclination, and the first direction is perpendicular to the second direction.

In some embodiments, the core lattice unit includes a top edge, a bottom edge and two side edges connecting the top edge and the bottom edge, the side edges of two adjacent core lattice units are connected with each other in the first direction, the bottom edge of the core lattice unit located above is connected with the top edge of the core lattice unit located below in the second direction, and the top edge and the bottom edge are not parallel to the first direction.

In some embodiments, the top edges of two adjacent core lattice units in the first direction have opposite directions of inclination, and the top edges of two adjacent core lattice units in the second direction have a same direction of inclination.

In some embodiments, there is a first included angle a1 between a line connecting two ends of the top edge and the first direction.

In some embodiments, there is a second included angle a2 between a line connecting two ends of the bottom edge and the first direction, and the first included angle a1 is equal to the second included angle a2.

In some embodiments, the first included angle a1 is greater than or equal to 3°.

In some embodiments, there is a third included angle a3 between one side edge of the core lattice unit and the top edge, and there is a fourth included angle a4 between the other side edge of the core lattice unit and the top edge, and the first included angle a1 is half of an absolute value of a difference between the third included angle a3 and the fourth included angle a4.

In some embodiments, a number of the edges of the core lattice unit is even, and diagonal angles of the core lattice unit are equal.

In some embodiments, the top edge and/or the bottom edge and/or the side edge are/is of a wavy structure.

According to another aspect of the disclosure, a manufacturing method for a flexible honeycomb structure is provided, the flexible honeycomb structure is the flexible honeycomb structure provided above, and the flexible honeycomb structure is made of a single-sheet forming strip. The manufacturing method for the flexible honeycomb structure includes: dividing the single-sheet forming strip into a plurality of to-be-processed sections which are arranged in sequence, each of the plurality of to-be-processed sections includes a plurality of strip units, and each of the plurality of strip units includes a concave edge, a first connecting edge, a convex edge and a second connecting edge which are connected in sequence; setting a previous to-be-processed section as a reference section, flipping a current to-be-processed section towards the reference section, and sequentially flipping remaining to-be-processed sections according to an above method until the flexible honeycomb structure is formed; during flipping, the concave edge of the strip unit of the reference section attaches to the concave edge of a corresponding strip unit of the current to-be-processed section, the first connecting edge, the convex edge and the second connecting edge of the strip unit of the reference section and the first connecting edge, the convex edge and the second connecting edge of the corresponding strip unit of the current to-be-processed section, so that the strip unit of the reference section and the corresponding strip unit of the current to-be-processed section enclose the core lattice unit of the flexible honeycomb structure.

In some embodiments, an operation of setting a previous to-be-processed section as a reference section, and flipping a current to-be-processed section towards the reference section specifically includes: when the current to-be-processed section attaches to the reference section, contact attaching edges of the current to-be-processed section and the reference section have a same direction of inclination.

In some embodiments, a connection mode of an attaching joint of the current to-be-processed section and the reference section includes welding, bonding and mechanical connection.

According to another aspect of the disclosure, a manufacturing method for a flexible honeycomb structure is provided, the flexible honeycomb structure is the flexible honeycomb structure provided above, and the manufacturing method for the flexible honeycomb structure includes 3D printing, CNC machining and casting.

By an adoption of technical solutions of the disclosure, the flexible honeycomb structure includes a plurality of core lattice units, each of the plurality of core lattice units is of the polygonal structure, and the plurality of core lattice units combine with each other to form the flexible honeycomb structure. Specifically, each of the plurality of core lattice units is of an inclined structure, two adjacent core lattice units in the first direction have opposite directions of inclination, two adjacent core lattice units in the second direction have the same direction of inclination, and the first direction is perpendicular to the second direction. By adopting above structures, when the flexible honeycomb structure is bent, the core lattice units are prone to tilt and folded-deform. The core lattice units are prone to deformation due to stress stretching or compression, and the deformation does not only depend on elasticity the material, so that the flexible honeycomb structure is prone to flexible deformation, and therefore, the problem of the honeycomb structure and a composite material having the honeycomb structure generating a saddle shape during a bending process is solved.

### BRIEF DESCRIPTION OF THE DRAWINGS

The drawings, which form a part of the disclosure, serve to provide a further understanding of the disclosure, and illustrative embodiments of the disclosure and descriptions of the disclosure serve to explain the disclosure and are not to be construed as unduly limiting the disclosure. In the drawings:

FIG. 1 illustrates a schematic structure diagram of a flexible honeycomb structure provided by Embodiment I of the disclosure.

FIG. 2 illustrates a schematic structure diagram of a core lattice unit in FIG. 1.

FIG. 3 illustrates a schematic structure diagram of another structure of a flexible honeycomb structure provided by Embodiment I of the disclosure.

FIG. 4 illustrates a schematic structure diagram of a core lattice unit in FIG. 3.

FIG. 5 illustrates a schematic structure diagram of a single-sheet forming strip provided by Embodiment IV of the disclosure.

FIG. 6 illustrates a schematic structure diagram of core lattice units enclosed by the single-sheet forming strip provided by Embodiment IV of the disclosure.

FIG. 7 illustrates another schematic structure diagram of the single-sheet forming strip provided by Embodiment IV of the disclosure.

FIG. 8 illustrates a schematic structure diagram of flipping of the single-sheet forming strip provided by Embodiment IV of the disclosure.

FIG. 9 illustrates a schematic structure diagram after further flipping of the single-sheet forming strip in FIG. 8.

FIG. 10 illustrates a schematic structure diagram after further flipping of the single-sheet forming strip in FIG. 9.

FIG. 11 illustrates a schematic structure diagram completing overturning of the single-sheet forming strip in FIG. 10.

FIG. 12 illustrates a schematic structure diagram of continuous flipping of the single-sheet forming strip provided by Embodiment IV of the disclosure.

FIG. 13 illustrates a schematic structure diagram of a flexible honeycomb structure provided by Embodiment II of the disclosure.

FIG. 14 illustrates a schematic structure diagram of a core lattice unit in FIG. 13.

FIG. 15 illustrates another schematic structure diagram of the single-sheet forming strip provided by Embodiment IV of the disclosure.

FIG. 16 illustrates another schematic structure diagram of continuous flipping of the single-sheet forming strip provided by Embodiment IV of the disclosure.

FIG. 17a illustrates a schematic structure diagram during compression of the flexible honeycomb structure provided by Embodiment I of the disclosure.

FIG. 17b illustrates a schematic structure diagram during compression of the flexible honeycomb structure provided by Embodiment I of the disclosure.

FIG. 17c illustrates a schematic structure diagram during compression of the flexible honeycomb structure provided by Embodiment I of the disclosure.

FIG. 17d illustrates a schematic structure diagram during compression of the flexible honeycomb structure provided by Embodiment I of the disclosure.

FIG. 17e illustrates a schematic structure diagram during compression of the flexible honeycomb structure provided by Embodiment I of the disclosure.

FIG. 18a illustrates a schematic structure diagram during stretching of another structure of the flexible honeycomb structure provided by Embodiment I of the disclosure.

FIG. 18b illustrates a schematic structure diagram during stretching of another structure of the flexible honeycomb structure provided by Embodiment I of the disclosure.

FIG. 18c illustrates a schematic structure diagram during stretching of another structure of the flexible honeycomb structure provided by Embodiment I of the disclosure.

FIG. 18d illustrates a schematic structure diagram during stretching of another structure of the flexible honeycomb structure provided by Embodiment I of the disclosure.

FIG. 19 illustrates a schematic structure diagram of a core lattice unit of a flexible honeycomb structure provided by Embodiment III of the disclosure.

The above drawings include the following reference numbers:

10. Core lattice unit; 11. Top edge; 12. Bottom edge; 13. Side edge;

20. Single-sheet forming strip; 21. To-be-processed section; 211. Strip unit; 2111. Concave edge; 2112. First connecting edge; 2113. Convex edge; 2114. Second connecting edge;

a1. First included angle; a2. Second included angle; a3. Third included angle; a4. Fourth included angle;

p1. Vertex of a core lattice unit; p2. Vertex of a core lattice unit; p3, Vertex of a core lattice unit; p4. Vertex of a core lattice unit; p5. Vertex of a core lattice unit; p6. Vertex of a core lattice unit.

### DETAILED DESCRIPTION OF THE EMBODIMENTS

The technical solutions in the embodiments of the disclosure will be clearly and completely described below in combination with the drawings in the embodiments of the disclosure. It is apparent that the described embodiments are not all embodiments but part of embodiments of the disclosure. The following description for at least one exemplary embodiment is merely illustrative in nature and is in no way intended to limit the disclosure, its application, or uses. All other embodiments obtained by those of ordinary skill in the art based on the embodiments of the disclosure without creative efforts shall fall within the protection scope of the disclosure.

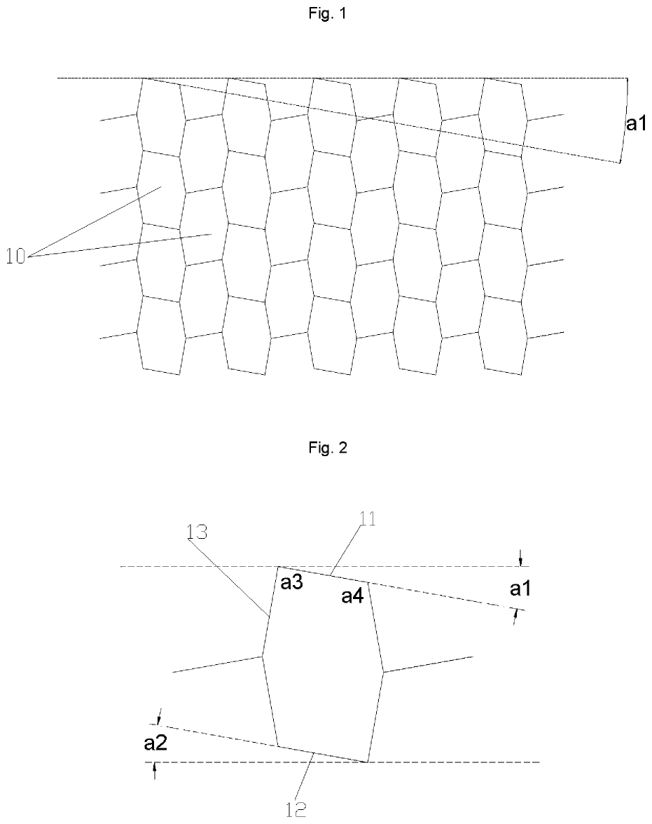

As shown in FIGS. 1-4, Embodiment I of the disclosure provides a flexible honeycomb structure, which includes a plurality of core lattice units 10, each of the plurality of core lattice units 10 is of a polygonal structure, and the plurality of core lattice units 10 combine with each other to form the flexible honeycomb structure. Each of the core lattice unit 10 is of an inclined structure, two adjacent core lattice units 10 in a first direction have opposite directions of inclination, two adjacent core lattice units 10 in a second direction have a same direction of inclination, and the first direction is perpendicular to the second direction. In the embodiment, the first direction is a horizontal direction, and the second direction is a vertical direction. Specifically, the polygonal structure includes various structures such as a quadrangle and a hexagon, as long as it is satisfied that the core lattice unit 10 is of an inclined structure.

By an adoption of the flexible honeycomb structure provided by the embodiment, each of the plurality of core lattice units 10 is of an inclined structure, directions of inclination of the core lattice units 10 are correspondingly configured in the first direction and the second direction, when the flexible honeycomb structure is bent, the core lattice units 10 are prone to tilt and folded-deform, the core lattice units 10 are prone to deformation due to stress stretching or compression, and the deformation does not only depend on elasticity of the material, the flexible honeycomb has a wide stretching and contracting flexibility, so that the flexible honeycomb structure is prone to flexible deformation, therefore, a problem of the honeycomb structure and a composite material having the honeycomb structure generating a saddle shape during a bending process is solved, and a processing cost is reduced.

In the embodiment, the honeycomb structure and composite material having the honeycomb structure include a honeycomb structural material, or (and) a plate-shaped honeycomb structural material made of the honeycomb structural material, or (and) a honeycomb composite material (including a porous plate composite structure) made of the honeycomb structural material. By the adoption of the flexible honeycomb structure provided by the embodiment, a problem of a typical multi-curved-surface honeycomb sandwich plate structure composite material in the related art generating a saddle shape during a bending process would not occur.

As shown in FIG. 2, each of the plurality of core lattice units 10 includes a top edge 11, a bottom edge 12 and two side edges 13 connecting the top edge 11 and the bottom edge 12. The side edges 13 of two adjacent core lattice units 10 are connected with each other in the first direction to connect the core lattice units 10 on each row of the flexible honeycomb structure. The bottom edge 12 of the core lattice unit 10 located above is connected with the top edge 11 of the core lattice unit 10 located below in the second direction to connect the core lattice cells 10 on each row of the flexible honeycomb structure, and the top edge 11 and the bottom edge 12 are not parallel to the first direction.

In the embodiment, the core lattice unit 10 is of a hexagonal structure, each edge of the core lattice unit has an equal length, and each side edge 13 includes two interconnected segments. In other embodiments, a number of edges of the core lattice unit 10 may be adjusted according to needs of use, and the embodiment is exemplified only by a hexagonal structure. For example, the core lattice unit 10 may be configured as a polygonal structure with other numbers of edges, such as a quadrangle and an octagon, or a profiled honeycomb structure.

Specifically, the top edges 11 of two adjacent core lattice units 10 in the first direction have opposite directions of inclination, and the top edges 11 of two adjacent core lattice units 10 in the second direction have the same direction of inclination, therefore, when the flexible honeycomb structure is bent, the core lattice unit 10 is prone to tilt and folded-deform.

As shown in FIG. 2, there is a first included angle a1 between a line connecting two ends of the top edge 11 and the first direction. In the embodiment, the top edge 11 is of a linear structure, and there is a first included angle a1 between the top edge 11 and the first direction. In other embodiments, the top edge may be configured as an inclined zigzag or wavy structure, as long as it is ensured that the top edge is not parallel to the first direction.

As shown in FIG. 2, there is a second included angle a2 between a line connecting two ends of the top edge 12 and the first direction. In the embodiment, the bottom edge 12 is of a linear structure, and there is a second included angle a2 between the bottom edge 12 and the first direction. In other embodiments, the bottom edge may be configured as an inclined zigzag or wavy structure, as long as it is ensured that the bottom edge is not parallel to the first direction.

In the embodiment, the first included angle a1 is equal to the second included angle a2, a shape of the core lattice unit is relatively regular, so that while the core lattice unit is prone to tilt and folded-deform, the flexible honeycomb structure is convenient to process.

The first included angle is greater than or equal to 3°, when the first included angle is greater than or equal to 3°, a stable structure of a hexagon is destroyed, so that the core lattice unit is prone to tilt and folded-deform, and certainly the larger the first included angle is, the more prone to tilt and stretchingly-compressingly deform. If the first included angle is smaller than 3°, the core lattice unit is not prone to tilt and folded-deform. Specifically, the first included angle may be set between 3° and 60°. In the embodiment, the first included angle is 10°.

As shown in FIG. 2, there is a third included angle a3 between one side edge 13 of the core lattice unit 10 and the top edge 11, there is a fourth included angle a4 between the other side edge 13 of the core lattice unit 10 and the top edge 11, and the first included angle a1 is half of an absolute value of a difference between the third included angle a3 and the fourth included angle a4.

In the embodiment, the number of the edges of the core lattice unit 10 is even, and diagonal angles of the core lattice unit 10 are equal, so that the core lattice unit is not prone to tilt and folded-deform. In the embodiment, opposite edges of the core lattice unit are equidistant. The embodiment is exemplified only with the number of the edges of the core lattice unit being even, and the number of the edges of the core lattice unit and parity of the number of the edges of the core lattice unit are not limited.

In the embodiment, the flexible honeycomb structure further includes a face plate covering an outside of the core lattice units, and the face plate may be made of a composite material or (and) a porous plate. The core lattice units are supported by the face plate, so that a strength and a mechanical property of the flexible honeycomb structure are guaranteed, and a composite structure a honeycomb core and the porous face plate embodies noise elimination and excellent acoustic performance.

In the related art, a conventional core lattice unit is of a regular hexagonal structure, when the conventional core lattice unit is horizontally placed, a top edge and a bottom edge of the core lattice unit are parallel to the horizontal direction, and due to a fact that the conventional regular hexagonal core lattice units have independent spaces and restrict each other, it is not easy to deform and easy to generate a saddle shape by stretching bending and contracting bending depending on elasticity of the conventional core lattice unit. By the adoption of the flexible honeycomb structure provided by the embodiment, the top edge and the bottom edge of the core lattice unit have an inclined angle, so that the stable structure of a hexagon is destroyed, when an acting force is applied to the core lattice unit in the horizontal direction, the core lattice unit tilts and stretchingly-compressingly deforms along inclined opposite angles of the hexagon, so that the whole core lattice unit is flexibly deformed, in a horizontal direction and a vertical direction (a circumferential direction and an axial direction of curvature) of the flexible honeycomb structure, the flexible honeycomb structure has wide stretching and contracting flexibility according to a stress condition of stretching and compression, so that the problem that the honeycomb structure generating a saddle shape during a bending process is avoided.

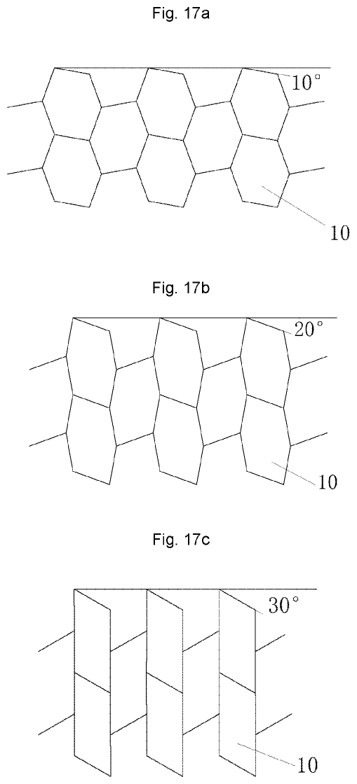

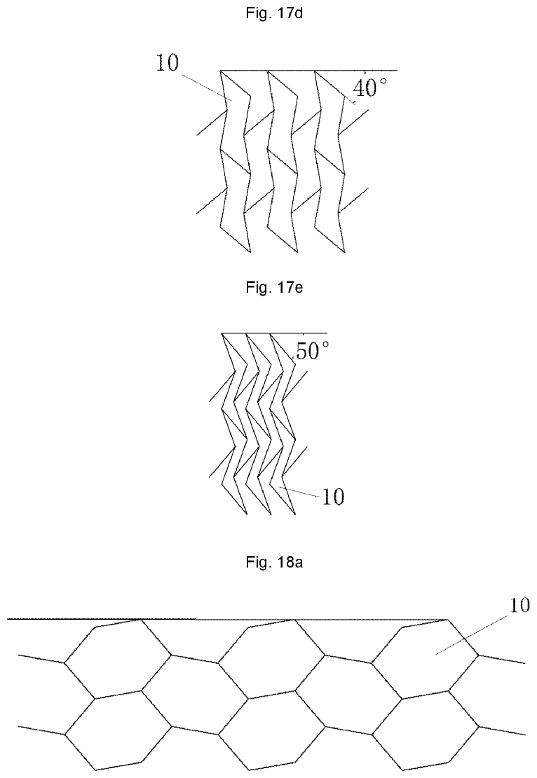

FIGS. 17a to 17e illustrate schematic structure diagrams during gradual compression of the flexible honeycomb structure, and the first included angle is changed from 10° to 20°, 20° to 30°, 30° to 40°, and 40° to 50°. Each of the core lattice units is of an inclined structure, the whole flexible honeycomb structure is in an inclined state, when the core lattice units of the flexible honeycomb structure is subjected to compression force in the horizontal direction, the opposite angles of the core lattice unit tend to folding deformation. The first included angle varies as with acting force changes, the larger the acting force is, the larger the folding deformation of the core lattice unit is, and the larger a change of the first included angle is. When the flexible honeycomb structure is deformed to an extreme position, the flexible honeycomb structure is in a folded state, and a maximum flexible change is achieved.

In a similar way, when the flexible honeycomb structure is subjected to stretching force in the horizontal direction, the opposite angles of the core lattice unit tend to unfold the folding deformation, the first included angle varies as with acting force change changes, the larger the acting force is, the larger the unfolding of the folding deformation of the core lattice unit is, and the larger the change of the first included angle is.

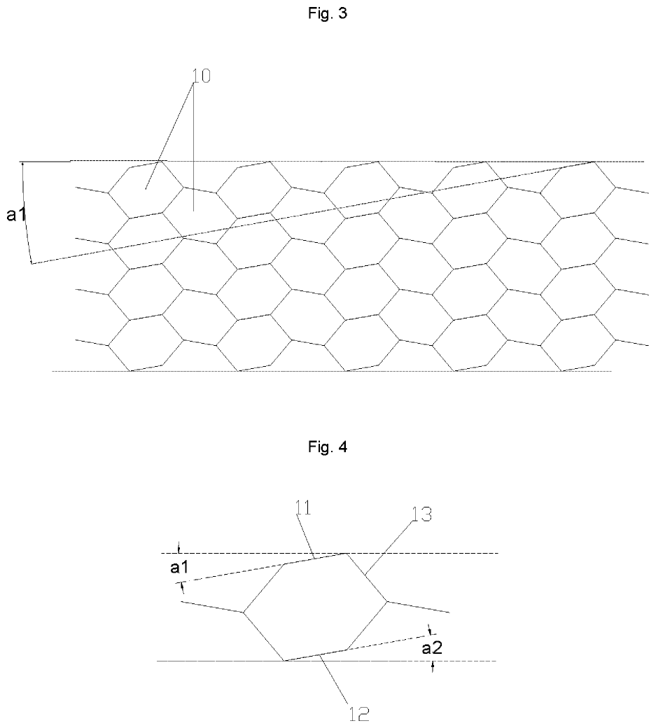

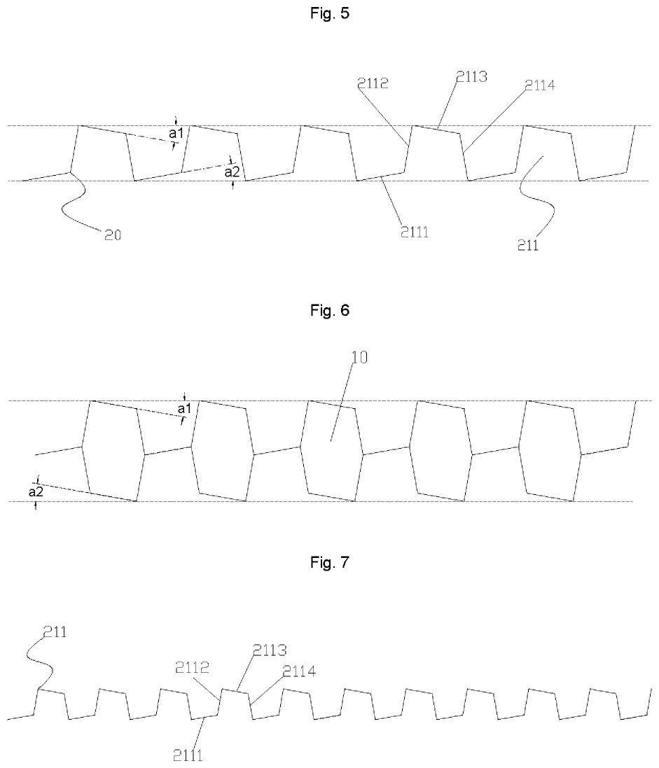

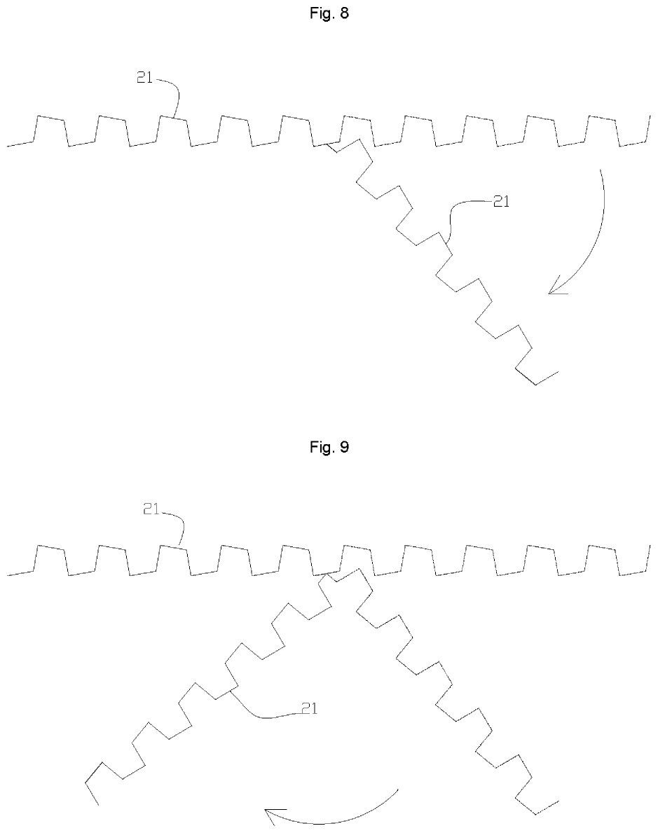

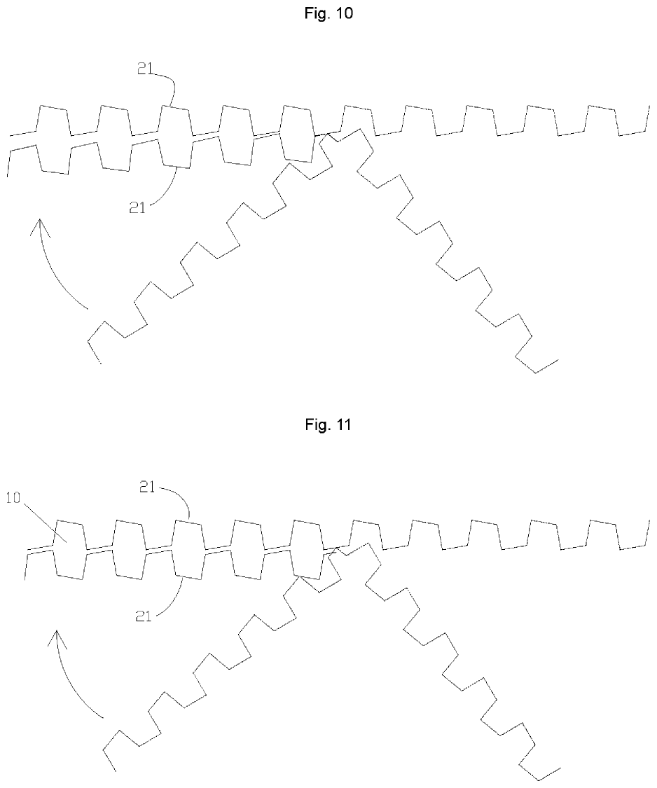

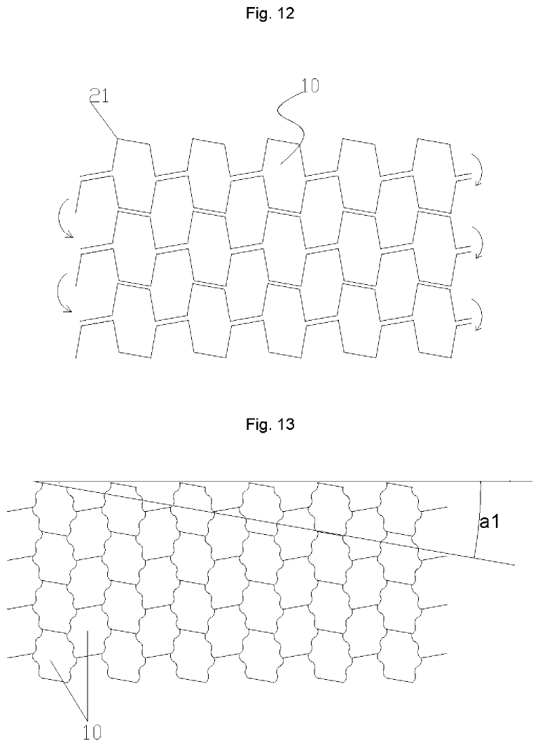

As shown in FIG. 3 and FIG. 4, the embodiment provides a flexible honeycomb structure of another structure.

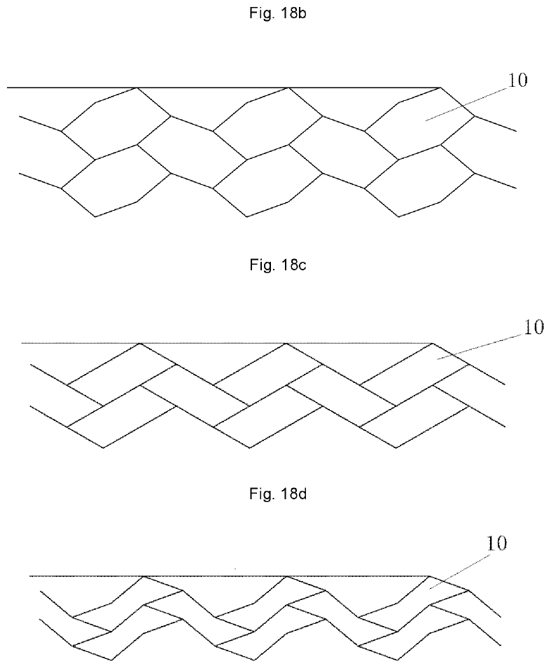

FIGS. 18A-18d illustrate schematic structure diagrams during gradual stretching of the flexible honeycomb structure of another structure, which is symmetric to the previous structure, so that the stretching and compressing change processes are also the same.

When the flexible honeycomb structure is bent, stretching and compressing act at a same time, and the whole flexible honeycomb structure flexibly stretches and compresses along with curvature changes, so that a saddle shape is avoided.

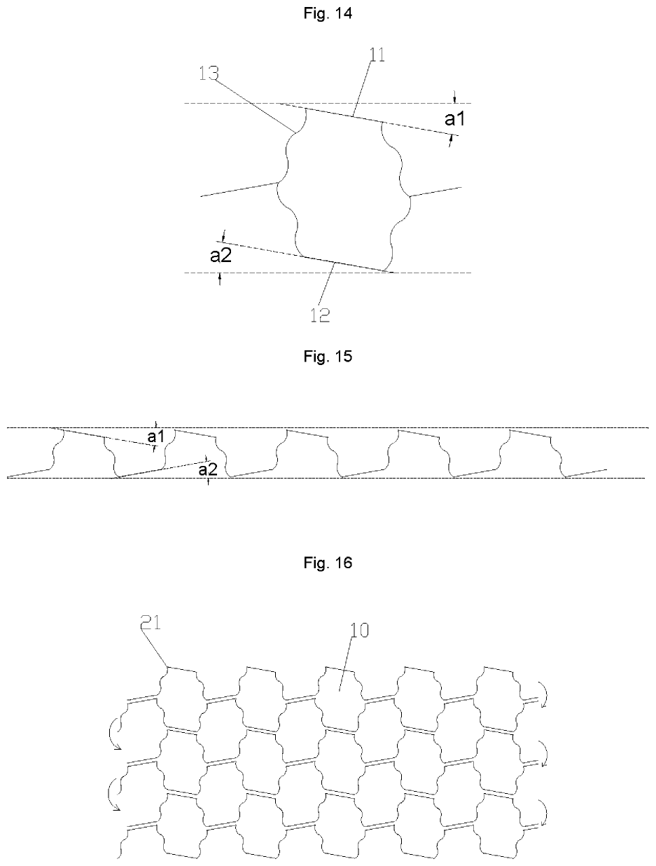

As shown in FIG. 13 and FIG. 14, Embodiment II of the disclosure provides a flexible honeycomb structure, which differs from Embodiment I in that in the Embodiment 2, side edges 13 of a core lattice unit 10 are of a wavy structure, a flexible deformation characteristic of the flexible honeycomb structure is more prominent, and a stretching and compressing flexibility and a specific strength of the flexible honeycomb structure are better than those of Embodiment I. In the embodiment, the side edges 13 are two interconnected segments, each of which is provided with three continuous wavy structures. The wavy structures may be other concave-convex shapes.

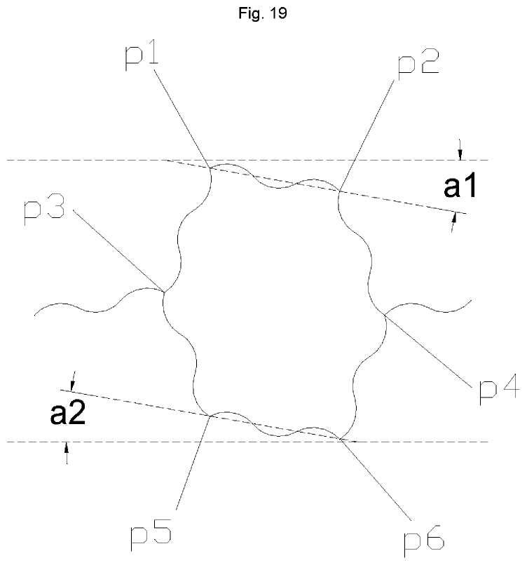

As shown in FIG. 19, Embodiment III of the disclosure provides a flexible honeycomb structure, which differs from Embodiment I in that in Embodiment III, a top edge, a bottom edge and side edges of a core lattice unit 10 are of a wavy structure, and a flexible deformation characteristic of the flexible honeycomb structure is more prominent. Wherein p1, p2, p3, p4, p5 and p6 are six vertexes of the core lattice unit respectively, a connecting line of p1 and p2 is a line connecting two ends of the top edge 11 of the core lattice unit, and there is a first included angle a1 between the line connecting two ends of the top edge 11 of the core lattice unit and a first direction, a connecting line of p5 and p6 is a line connecting two ends of the bottom edge 12 of the core lattice unit, and there is a second included angle a2 between the line connecting two ends of the bottom edge 12 and the first direction, and the first included angle a1 is equal to the second included angle a2.

In other embodiments, shapes of a top edge, a bottom edge, and side edges of a core lattice unit 10 may be adaptively adjusted. For example, only the top edge of the core lattice unit 10 is configured as a wavy structure, or only the bottom edge of the core lattice unit 10 is configured as a wavy structure.

As shown in FIGS. 5 -12 and FIG. 15 and FIG. 16, Embodiment IV of the disclosure provides a manufacturing method for a flexible honeycomb structure, the flexible honeycomb structure is the flexible honeycomb structure provided above, the flexible honeycomb structure is made of a single-sheet forming strip 20, and the manufacturing method for the flexible honeycomb structure includes following steps.

S100, dividing the single-sheet forming strip 20 into a plurality of to-be-processed sections 21 which are arranged in sequence, each of the plurality of to-be-processed sections 21 includes a plurality of strip units 211, and each of the plurality of strip units 211 includes a concave edge 211, a first connecting edge 2112, a convex edge 2113 and a second connecting edge 2114 which are connected in sequence.

S200, setting a previous to-be-processed section 21 as a reference section, flipping a current to-be-processed section 21 towards the reference section, and sequentially flipping remaining to-be-processed sections 21 according to an above method until the flexible honeycomb structure is formed.

During flipping, the concave edge 2111 of the strip unit 211 of the reference section attaches to the concave edge 2111 of a corresponding strip unit 211 of the current to-be-processed section 21, the first connecting edge 2112, the convex edge 2113 and the second connecting edge 2114 of the strip unit 211 of the reference section and the first connecting edge 2112, the convex edge 2113 and the second connecting edge 2114 of the corresponding strip unit 211 of the current to-the-processed section 21 are closed, so that the strip unit 211 of the reference section and the corresponding strip unit 211 of the current to-be-processed section 21 enclose a core lattice unit 10 of the flexible honeycomb structure.

An operation of setting a previous to-be-processed section 21 as a reference section, flipping a current to-be-processed section 21 towards the reference section specifically includes: when the current to-be-processed section 21 attaches to the reference section, contact attaching edges of the current to-be-processed section 21 and the reference section have a same direction of inclination. In the embodiment, during flipping, the concave edge 2111 of the strip unit 211 of the reference section attaches to the concave edge 2111 of the corresponding strip unit 211 of the current to-be-processed section 21, and the concave edge 2111 of the strip unit 211 of the reference section and the concave edge 2111 of the corresponding strip unit 211 of the current to-be-processed section 21 have the same direction of inclination.

Specifically, an operation of dividing the single-sheet forming strip 20 into a plurality of to-be-processed sections 21 which are arranged in sequence includes the following two modes.

(1) Dividing the single-sheet forming strip 20 into a plurality of to-be-processed sections 21 which are sequentially connected, during processing, setting a previous to-be-processed section 21 as a reference section, flipping a current to-be-processed section 21 towards the reference section, and sequentially flipping remaining to-be-processed sections 21 according to an above method until the flexible honeycomb structure is formed.

(2) Dividing the single-sheet forming strip into a plurality of to-be-processed sections which are not connected, during processing, setting a previous to-be-processed section as a reference section, flipping a current to-be-processed section towards the reference section, and sequentially flipping remaining to-be-processed sections according to an above method until the flexible honeycomb structure is formed.

A continuous forming strip is reversely stacked and spliced (overturned), and is then stacking and splicing back and forth sequentially to form the flexible honeycomb structure. The forming strip to be reversely stacked and spliced can be a continuous forming strip or a plurality of discontinuous forming strips (a plurality of to-be-processed sections 21 which are not connected)

A connection mode of an attaching joint of the current to-be-processed section 21 and the reference section includes welding, bonding and mechanical connection, and a splicing process of the to-be-processed sections 21 circulates back and forth, which is easy to achieve automation. Specifically, bonding includes gluing.

In the embodiment, the flexible honeycomb structure is sequentially and reversely splicing from top to bottom, and in other embodiments, the flexible honeycomb structure may be spliced by a continuous forming strip from bottom to top.

According to the manufacturing method for the flexible honeycomb structure provided by the embodiment, the core lattice units are formed by splicing the single-sheet forming strip reversely, so that deformation directions of the core lattice units are consistent, no confrontation force restricting each other exists, the core lattice units are prone to tilt and stretching-compressing deform along opposite angles, the whole flexible honeycomb structure has integral stretching-compressing flexible deformation, meanwhile, a manufacturing process is simple, and it is easy to implement, a cost is low, and a flexible range is large.

Embodiment V of the disclosure provides a manufacturing method for a flexible honeycomb structure, the flexible honeycomb structure is the flexible honeycomb structure provided above, and the manufacturing method for the flexible honeycomb structure includes 3D printing, CNC machining and casting. For example, a whole piece of to-be-processed material is processed by numerical control milling, or pre-manufacturing a mold and then manufacturing by casting.

The embodiment has following beneficial effects.

(1) A structure of the core lattice unit is changed, so that the core lattice unit is prone to fold after opposite sides of the core lattice unit are stressed, meanwhile, interiors of the core lattice unit do not against each other during stretched-compressed deformation, stretching-compressing deformation directions of the flexible honeycomb structure are consistent, the flexible honeycomb structure has a characteristic of integral stretching-compressing flexible deformation, and deformation of the flexible honeycomb structure does not depend only on an elasticity of material.

(2) The flexible honeycomb structure is formed by sequentially and reversely splicing the forming strip, a forming process is simple, a back-and-forth circulation process is continuous, and automation is easy to realize especially for a continuous forming strip.

(3) The flexible honeycomb is simple in structure and easy to manufacture and is closest to a conventional honeycomb in form structure, when the flexible honeycomb structure is bent, the flexible honeycomb structure stretches and compresses along with an angle change of the first included angle, and when the first included angle is 0, the flexible honeycomb structure is a conventional hexagonal honeycomb.

(4) Each edge of each core lattice units of the flexible honeycomb structure can be formed by combining various shapes such as a wavy shape and/or other concave-convex shapes.

The foregoing is merely preferred embodiment of the disclosure and is not intended to limit the disclosure, and various modifications and variations of the disclosure may be available for those skilled in the art. Any modifications, equivalents, improvements, etc., made within the spirit and principles of the disclosure are intended to be included within the scope of protection of the disclosure.

What is claimed is:

1. A flexible honeycomb structure, comprising a plurality of core lattice units, each of the plurality of core lattice units is of a polygonal structure, and the plurality of core lattice units combine with each other to form the flexible honeycomb structure, each of the plurality of core lattice units is of an inclined structure, two adjacent core lattice units in a first direction have opposite directions of inclination, two adjacent core lattice units in a second direction have a same direction of inclination, and the first direction is perpendicular to the second direction.

2. The flexible honeycomb structure as claimed in claim 1, wherein the core lattice unit comprises a top edge, a bottom edge and two side edges connecting the top edge and the bottom edge, the side edges of two adjacent core lattice units are connected with each other in the first direction, the bottom edge of the core lattice unit located above is connected with the top edge of the core lattice unit located below in the second direction, and the top edge and the bottom edge are not parallel to the first direction.

3. The flexible honeycomb structure as claimed in claim 2, wherein the top edges of two adjacent core lattice units in the first direction have opposite directions of inclination, and the top edges of two adjacent core lattice units in the second direction having a same direction of inclination.

4. The flexible honeycomb structure as claimed in claim 2, wherein there is a first included angle a1 between a line connecting two ends of the top edge and the first direction.

5. The flexible honeycomb structure as claimed in claim 4, wherein there is a second included angle a2 between a line connecting two ends of the bottom edge and the first direction, and the first included angle a1 is equal to the second included angle a2.

6. The flexible honeycomb structure as claimed in claim 4, wherein the first included angle a1 is greater than or equal to 3°.

7. The flexible honeycomb structure as claimed in claim 4, wherein there is a third included angle a3 between one side edge of the core lattice unit and the top edge, and there is a fourth included angle a4 between the other side edge of the core lattice unit and the top edge, and the first included angle a1 is half of an absolute value of a difference between the third included angle a3 and the fourth included angle a4.

8. The flexible honeycomb structure as claimed in claim 1, wherein a number of edges of the core lattice unit is even, and diagonal angles of the core lattice unit are equal.

9. The flexible honeycomb structure as claimed in claim 2, wherein the top edge and/or the bottom edge and/or the side edge are/is of a wavy structure.

10. A manufacturing method for a flexible honeycomb structure, wherein the flexible honeycomb structure is the flexible honeycomb structure as claimed in claim 1, the flexible honeycomb structure is made of a single-sheet forming strip, and the manufacturing method for the flexible honeycomb structure comprises:
dividing the single-sheet forming strip into a plurality of to-be-processed sections which are arranged in sequence, each of the plurality of to-be-processed sections comprises a plurality of strip units, and each of the plurality of strip units comprises a concave edge, a first connecting edge, a convex edge and a second connecting edge which are connected in sequence;
setting a previous to-be-processed section as a reference section, flipping a current to-be-processed section towards the reference section, and sequentially flipping remaining to-be-processed section according to an above method until the flexible honeycomb structure is formed;
wherein during flipping, the concave edge of the strip unit of the reference section attaches to the concave edge of a corresponding strip unit of the current to-be-processed section, the first connecting edge, the convex edge and the second connecting edge of the strip unit of the reference section and the first connecting edge, the convex edge and the second connecting edge of the corresponding strip unit of the current to-be-processed section are closed, so that the strip unit of the reference section and the corresponding strip unit of the current to-be-processed section enclose the core lattice unit of the flexible honeycomb structure.

11. The manufacturing method for the flexible honeycomb structure as claimed in claim 10, an operation of setting a previous to-be-processed section as a reference section, and flipping a current to-be-processed section towards the reference section specifically comprises:
when the current to-be-processed section attaches to the reference section, contact attaching edges of the current to-be-processed section and the reference section have a same direction of inclination.

12. The manufacturing method for the flexible honeycomb structure as claimed in claim 10, wherein a connection mode of an attaching joint of the current to-be-processed section and the reference section includes welding, bonding and mechanical connection.

13. A manufacturing method for a flexible honeycomb structure, the flexible honeycomb structure is the flexible honeycomb structure as claimed in claim 1, and the manufacturing method for the flexible honeycomb structure comprises 3D printing, CNC machining and casting.

14. The flexible honeycomb structure as claimed in claim 10, wherein the core lattice unit comprises a top edge, a bottom edge and two side edges connecting the top edge and the bottom edge, the side edges of two adjacent core lattice units are connected with each other in the first direction, the bottom edge of the core lattice unit located above is connected with the top edge of the core lattice unit located below in the second direction, and the top edge and the bottom edge are not parallel to the first direction.

15. The flexible honeycomb structure as claimed in claim 14, wherein the top edges of two adjacent core lattice units in the first direction have opposite directions of inclination, and the top edges of two adjacent core lattice units in the second direction having a same direction of inclination.

16. The flexible honeycomb structure as claimed in claim 14, wherein there is a first included angle a1 between a line connecting two ends of the top edge and the first direction.

17. The flexible honeycomb structure as claimed in claim 16, wherein there is a second included angle a2 between a line connecting two ends of the bottom edge and the first direction, and the first included angle a1 is equal to the second included angle a2.

18. The flexible honeycomb structure as claimed in claim 16, wherein the first included angle a1 is greater than or equal to 3°.

19. The flexible honeycomb structure as claimed in claim 16, wherein there is a third included angle a3 between one side edge of the core lattice unit and the top edge, and there is a fourth included angle a4 between the other side edge of the core lattice unit and the top edge, and the first included angle a1 is half of an absolute value of a difference between the third included angle a3 and the fourth included angle a4.

20. The flexible honeycomb structure as claimed in claim 10, wherein a number of edges of the core lattice unit is even, and diagonal angles of the core lattice unit are equal.
